(19) United States
(12) Patent Application Publication
(10) Pub. No.: US 2026/0019597 A1
(43) Pub. Date: Jan. 15, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); KIA CORPORATION, Seoul (KR)

(72) Inventors: Jin Heo, Yongin-si (KR); Seung Wook Park, Yongin-si (KR)

(73) Assignees: HYUNDAI MOTOR COMPANY, Seoul (KR); KIA CORPORATION, Seoul (KR)

(21) Appl. No.: 18/994,920

(22) PCT Filed: Jul. 27, 2023
(86) PCT No.: PCT/KR2023/010960

§ 371 Date: Jan. 15, 2025

(30) Foreign Application Priority Data
Jul. 28, 2022 (KR) 10-2022-0094221
Jul. 27, 2023 (KR) 10-2023-0098083

(51) Int. Cl. H04N 19/159; H04N 19/105; H04N 19/176; H04N 19/196

(52) U.S. Cl. CPC H04N 19/159; H04N 19/105; H04N 19/176; H04N 19/196

(57) ABSTRACT

An image encoding/decoding method and apparatus, a recording medium storing a bitstream and a transmission method are provided. The image decoding method may comprise determining an intra prediction mode of a current block, deriving a reference sample of an unreconstructed area, and performing intra prediction according to the intra prediction mode based on at least one of the derived reference sample of the unreconstructed area or a reference sample of a reconstructed area. The reference sample of the unreconstructed area may be a reference sample of an area located at at least one of a left bottom, bottom, right bottom, right or right top of the current block.

### CROSS-REFERENCE TO RELATED APPLICATIONS

This application is a U.S. national stage of International Application No. PCT/KR2023/010960, filed on Jul. 27, 2023, which claims priority to Korean Patent Application No. 10-2022-0094221 filed on Jul. 28, 2022, and Korean Patent Application No. 10-2023-0098083, filed on Jul. 27, 2023, the entire contents of each of which are hereby incorporated herein by reference.

### TECHNICAL FIELD

The present invention relates to an image

encoding/decoding method and apparatus and a recording medium for storing a bitstream. More particularly, the present invention relates to an image encoding/decoding method and apparatus based on reference sample derivation for intra prediction and an intra prediction method using the same and a recording medium for storing a bitstream.

### BACKGROUND

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

In the existing intra prediction method, when a neighboring reference sample of a current block cannot be used, a reference sample generated using a simple padding method was used for intra prediction. In this way, when a reference sample is derived using a simple padding method, there is a problem that the prediction accuracy is low.

### SUMMARY

An object of the present invention is to provide an image encoding/decoding method and apparatus with improved encoding/decoding efficiency.

Another object of the present invention is to provide a recording medium for storing a bitstream generated by an image decoding method or apparatus according to the present invention.

Another object of the present invention is to provide improved reference sample derivation for solving problems of a reference sample derivation method and an intra prediction method using the same.

An image decoding method according to an embodiment of the present invention may comprise determining an intra prediction mode of a current block, deriving a reference sample of an unreconstructed area and performing intra prediction according to the intra prediction mode based on at least one of the derived reference sample of the unreconstructed area or a reference sample of a reconstructed area. The reference sample of the unreconstructed area may be a reference sample of an area located at at least one of a left bottom, bottom, right bottom, right or right top of the current block.

In the image decoding method, the reference sample of the unreconstructed area may be derived based on neighboring samples of a matching block searched by performing template matching.

In the image decoding method, the reference sample of the unreconstructed area may be derived based on neighboring samples of a matching block in a current picture indicated by motion information of the current block.

In the image decoding method, the reference sample of the unreconstructed area may be derived based on a neural network model having the reference sample of the reconstructed area as input.

In the image decoding method, the intra prediction mode may be determined to be any one of a planar mode, a vertical planar mode, a horizontal planar mode, a DC mode or an angular mode.

In the image decoding method, when the intra prediction mode is determined to be a planar mode, intra prediction may be performed based on a reference sample of a reconstructed area corresponding to the top of a current pixel, a reference sample of a reconstructed area corresponding to the left, a reference sample of an un reconstructed area corresponding to the bottom and a reference sample of an unreconstructed area corresponding to the right.

In the image decoding method, when the intra prediction mode is determined to be a vertical planar mode, intra prediction may be performed based on a reference sample of a reconstructed area corresponding to the top of a current pixel and a reference sample of an unreconstructed area corresponding to the bottom.

In the image decoding method, when the intra prediction mode is determined to be a horizontal planar mode, intra prediction may be performed based on a reference sample of a reconstructed area corresponding to the left of a current pixel and a reference sample of an unreconstructed area corresponding to the right.

In the image decoding method, when the intra prediction mode is determined to be a DC mode, intra prediction may be performed based on a reference sample of a reconstructed area located at the top of the current block, a reference sample of a reconstructed area located at the left, a reference sample of an unreconstructed area located at the bottom and a reference sample of an unreconstructed area located at the right.

In the image decoding method, the determining the intra prediction mode may comprise parsing a planar flag and determining the intra prediction mode by parsing any one of planar mode information and intra prediction mode information according to the planar flag.

An image encoding method according to an embodiment of the present invention may comprise determining an intra prediction mode of a current block, deriving a reference sample of an unreconstructed area and performing intra prediction according to the intra prediction mode based on at least one of the derived reference sample of the unreconstructed area or a reference sample of a reconstructed area. The reference sample of the unreconstructed area may be a reference sample of an area located at at least one of a left bottom, bottom, right bottom, right or right top of the current block.

A non-transitory computer-readable recording medium according to an embodiment of the present invention may store a bitstream generated by an image encoding method comprising determining an intra prediction mode of a current block, deriving a reference sample of an unreconstructed area and performing intra prediction according to the intra prediction mode based on at least one of the derived reference sample of the unreconstructed area or a reference sample of a reconstructed area. The reference sample of the unreconstructed area may be a reference sample of an area located at at least one of a left bottom, bottom, right bottom, right or right top of the current block.

A transmission method according to an embodiment of the present invention may transmit a bitstream generated by an image encoding method comprising determining an intra prediction mode of a current block, deriving a reference sample of an unreconstructed area and performing intra prediction according to the intra prediction mode based on at least one of the derived reference sample of the unreconstructed area or a reference sample of a reconstructed area. The reference sample of the unreconstructed area may be a reference sample of an area located at at least one of a left bottom, bottom, right bottom, right or right top of the current block.

The features briefly summarized above with respect to the present disclosure are merely exemplary aspects of the detailed description below of the present disclosure, and do not limit the scope of the present disclosure.

According to the present invention, it is possible to provide an image encoding/decoding method and apparatus with improved encoding/decoding efficiency.

In addition, according to the present invention, it is possible to provide improved reference sample derivation and an intra prediction method using the same.

In addition, according to the present invention, it is possible to improve intra prediction accuracy.

It will be appreciated by persons skilled in the art that that the effects that can be achieved through the present disclosure are not limited to what has been particularly described hereinabove and other advantages of the present disclosure will be more clearly understood from the detailed description.

### BRIEF DESCRIPTION OF THE DRAWINGS

FIG. 1 is a block diagram showing a configuration of an encoding apparatus an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 is a diagram for explaining a padding-based reference sample derivation method according to an embodiment of the present invention.

FIG. 5 is a diagram for explaining a reference sample for intra prediction according to an embodiment of the present invention.

FIGS. 6 to 8 are diagrams for explaining a neural network-based reference sample derivation method according to an embodiment of the present invention.

FIGS. 9 to 11 are diagrams for explaining a template matching-based reference sample derivation method according to an embodiment of the present invention.

FIGS. 12 to 14 are diagrams for explaining a motion information-based reference sample derivation method according to an embodiment of the present invention.

FIG. 15 is a diagram for explaining an embodiment of a plurality of reference sample lines according to an embodiment of the present invention.

FIG. 16 is a diagram for explaining a planar mode according to an embodiment of the present invention.

FIG. 17 is a diagram for explaining a horizontal planar mode according to an embodiment of the present invention.

FIG. 18 is a diagram for explaining a vertical planar mode according to an embodiment of the present invention.

FIG. 19 is a diagram for explaining a DC mode according to an embodiment of the present invention.

FIGS. 20 and 21 are diagrams for explaining an angular mode according to an embodiment of the present invention.

FIG. 22 is a flowchart illustrating an intra prediction mode parsing method according to an embodiment of the present invention.

FIG. 23 is a flowchart illustrating an image decoding method according to an embodiment of the present invention.

FIG. 24 exemplarily illustrates a content streaming system to which an embodiment according to the present invention is applicable.

### DETAILED DESCRIPTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

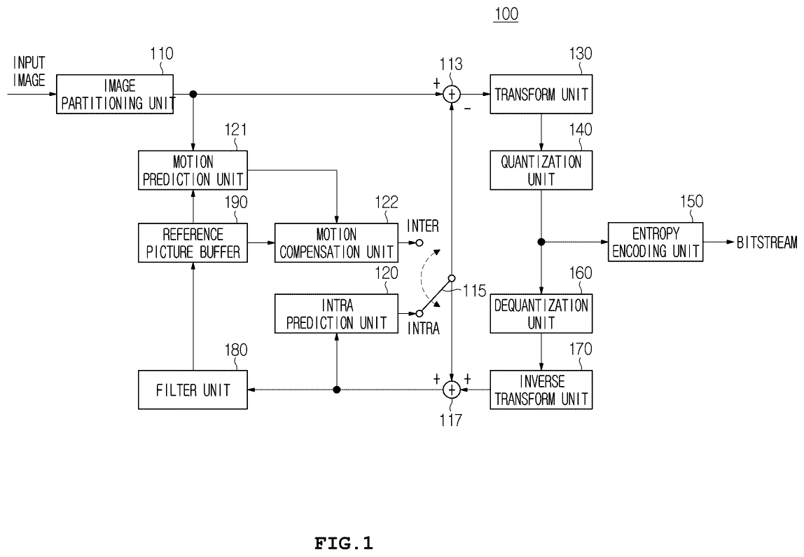

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In in the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LENST (LOW Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

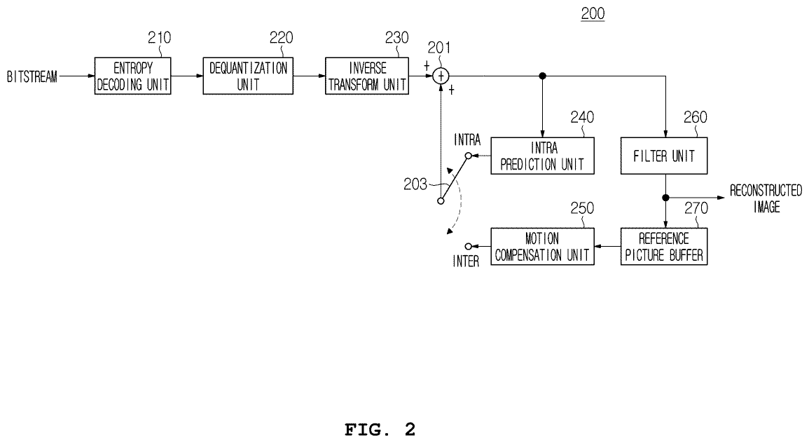

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the The decoding target block may be called a prediction block. current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

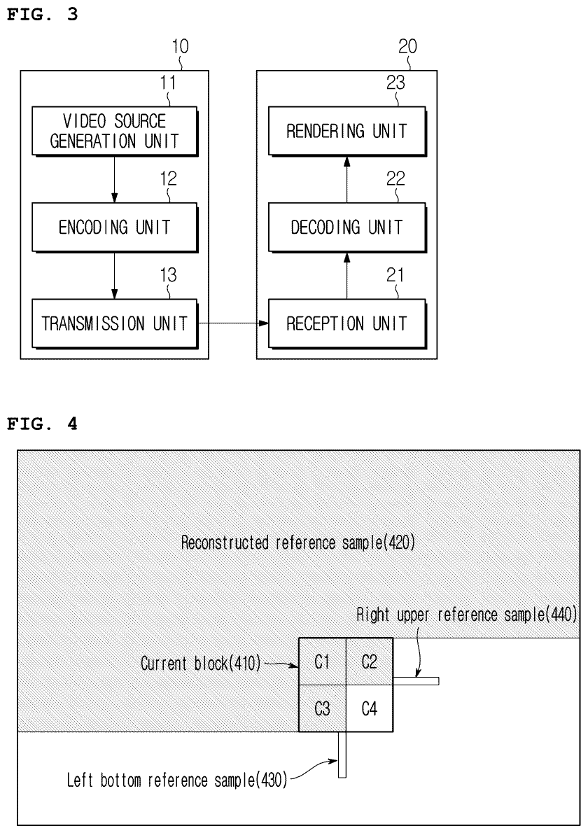

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

Hereinafter, with reference to FIGS. 4 to 23, a reference sample derivation method and an intra prediction method using the same according to an embodiment of the present invention will be described.

In the present invention, a reference sample may mean a reference pixel. In addition, when a sample of a reconstructed area is used as a reference sample for intra prediction, this may be called a reconstructed reference sample, and when a sample of an unreconstructed area is derived and used as a reference sample for intra prediction, this may be called a derived reference sample.

FIG. 4 is a diagram for explaining a padding-based reference sample derivation method according to an embodiment of the present invention.

In FIGS. 4, C1, C2, C3, and C4 are sub-blocks of a current block 410. Since encoding/decoding is performed in a raster scan order, when the C4 sub-block is encoded/decoded, the C1, C2, and C3 sub-blocks are reconstructed blocks. Therefore, the reconstructed samples of the C1, C2, and C3 sub-blocks may be used for intra prediction of the C4 sub-block as reconstructed reference sample 420 together with the previously reconstructed samples. The gray area in FIG. 4 may represent a reconstructed area where encoding/decoding is performed, and the white area may represent an area where encoding/decoding is not performed.

Meanwhile, if the intra prediction mode of the C4 sub-block is a mode smaller than a horizontal mode or a mode larger than a vertical mode, intra prediction must be performed using the left bottom reference sample 430 or the right upper reference sample 440, respectively. However, since the reference samples of the two areas cannot be used in the encoding/decoding order, the reference samples of the two areas may be derived by padding the available samples in the reconstructed area.

However, in such cases, it is difficult to reflect the characteristics of each reference sample in the corresponding area. Therefore, the accuracy of the reference sample is low and thus the accuracy of intra prediction may be lowered.

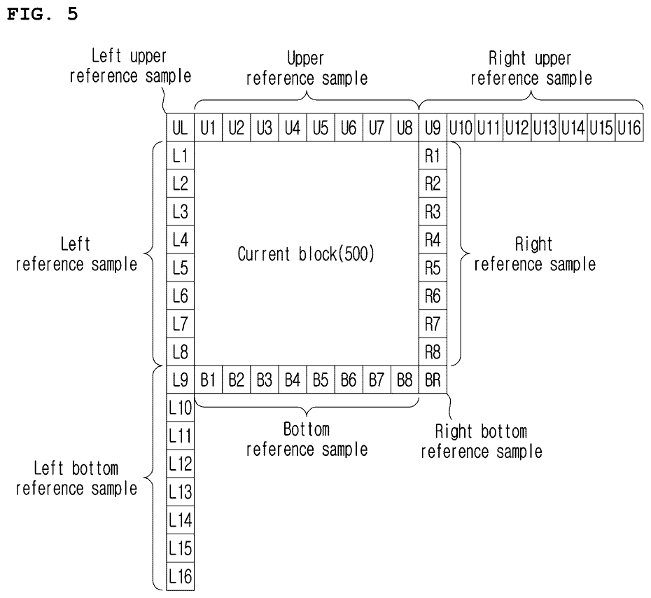

FIG. 5 is a diagram for explaining a reference sample for intra prediction according to an embodiment of the present invention.

Referring to FIG. 5, a reference sample for intra prediction of a current block 500 may be composed of at least one of left reference samples L1 to L8, a left upper reference sample 20 UL, upper reference samples U1 to U8, right upper reference samples U9 to U16, right reference samples R1 to R8, a right bottom reference sample BR, bottom reference samples B1 to B8, or left bottom reference samples L9 to L16. The reference sample according to the above-described position may be a sample area including a plurality of samples, or may be a reference sample composed of a single sample.

For example, the reference sample for intra prediction may be determined from among the left reference sample, the left upper reference sample, the upper reference sample, the right upper reference sample, and the left bottom reference sample. Here, the reconstructed reference sample may be the left reference sample, the left upper reference sample, and the upper reference sample, and the derived reference sample may be the right upper reference sample and the left bottom reference sample. In this specification, the type of the reference sample area may be referred to as a first type reference sample area.

As another example, the reference sample for intra prediction may be determined from among the left reference sample, the left upper reference sample, the upper reference sample, the right reference sample, the right bottom reference sample, and the bottom reference sample. Here, the reconstructed reference sample may be the left reference sample, the left upper reference sample, and the upper reference sample, and the derived reference samples may be the right reference sample, the right bottom reference sample, and the bottom reference sample. In this specification, the type of the reference sample area may be referred to as a second type reference sample area.

As another example, the reference sample for intra prediction may be determined from among the left reference sample, the left upper reference sample, the right upper reference sample, the right reference sample, the right bottom reference sample, the bottom reference sample, and the left bottom reference sample. Here, the reconstructed reference samples are the left reference sample, the left upper reference sample, and the upper reference sample, and the derived reference samples may be the right upper reference sample, the left bottom reference sample, the right reference sample, the right bottom reference sample, and the bottom reference sample. In this specification, the type of the reference sample area may be referred to as a third type reference sample area.

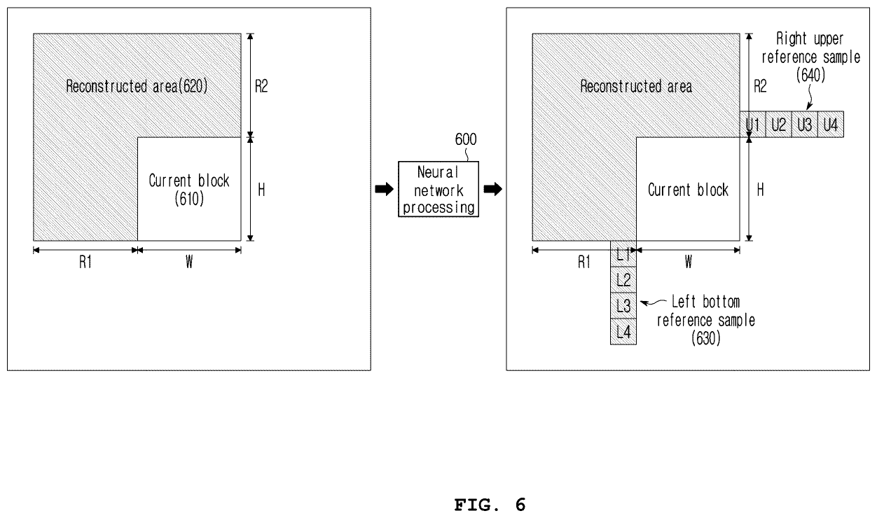

FIGS. 6 to 8 are diagrams for explaining a neural network-based reference sample derivation method according to an embodiment of the present invention. Specifically, FIGS. 6, 7 and 8 are diagrams for explaining a neural network-based reference sample derivation method for constructing a first type reference sample area, a second type reference sample area and a third type reference sample area, respectively.

Referring to FIG. 6, an encoder/decoder may input samples of a reconstructed area 620 around a current block 610 to a neural network processing unit 600 to derive left bottom reference samples L1 to L4 630 and right upper reference samples U1 to U4 640 of an unreconstructed area.

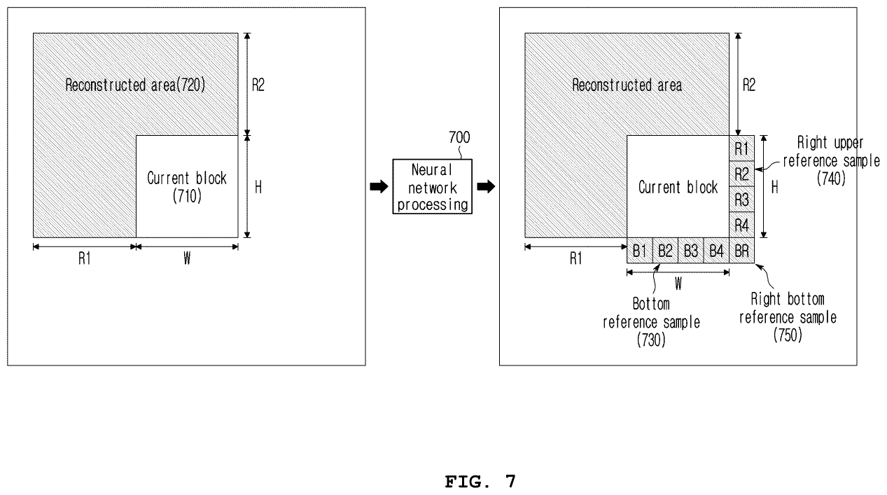

Referring to FIG. 7, an encoder/decoder may input samples of a reconstructed area 720 around a current block 710 to a neural network processing unit 700 to derive bottom reference samples B1 to B4 730, right reference samples R1 to R4 740, and a right bottom reference samples BR 750 of an unreconstructed area.

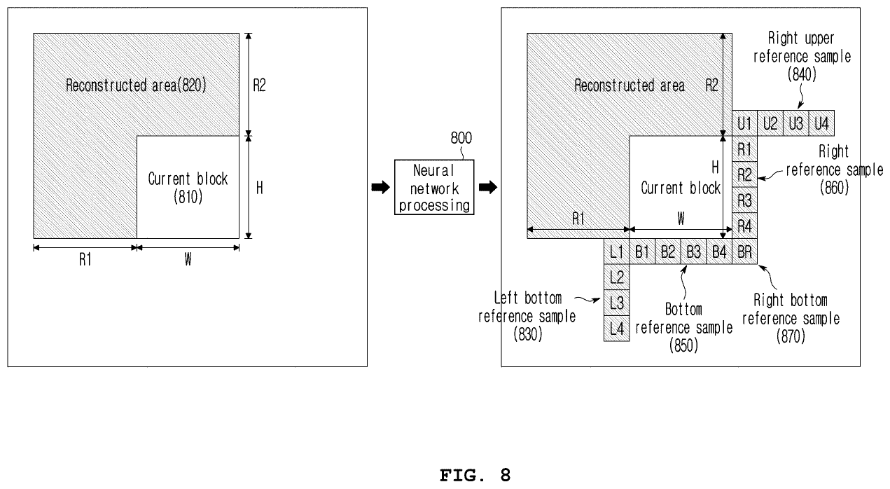

Referring to FIG. 8, an encoder/decoder may input samples of a reconstructed area 820 around a current block 810 to a neural network processing unit 800 to derive left bottom reference samples L1 to L4 830, right upper reference samples U1 to U4 840, bottom reference samples B1 to B4 850, right reference samples R1 to R4 860, and a right bottom reference samples BR 870 of an unreconstructed area.

Meanwhile, the size of the reconstructed samples around the current block, which is the input of the neural network processing unit, may be determined based on signaling information. For example, the size of the reconstructed samples used as the input of the neural network processing unit may be (R1×2H)+(2W×R2)+(R1×R2). At this time, the sizes of R1 and R2 may be determined in the encoder and transmitted to the decoder. As another example, the size of the reconstructed samples used as the input of the neural network processing unit may be (R1×H)+(W×R2)+(R1×R2).

Meanwhile, the size of the reconstructed samples around the current block, which is the input of the neural network processing unit, may be a fixed size that is determined in advance.

The neural network processing unit may be implemented as a neural network model. Here, the artificial neural network model may represent a deep neural network including one or more neural network layers. In addition, the neural network model may include all or part of a convolution layer, a fully-connected layer, and a pooling layer. The neural network model may be implemented in a form including one type of neural network layer, or may be implemented in a form in which different types of layers are additionally combined.

Meanwhile, initial internal parameters of the neural network model used in the neural network processing unit are pre-learned, but may be additionally learned during the encoding/decoding process.

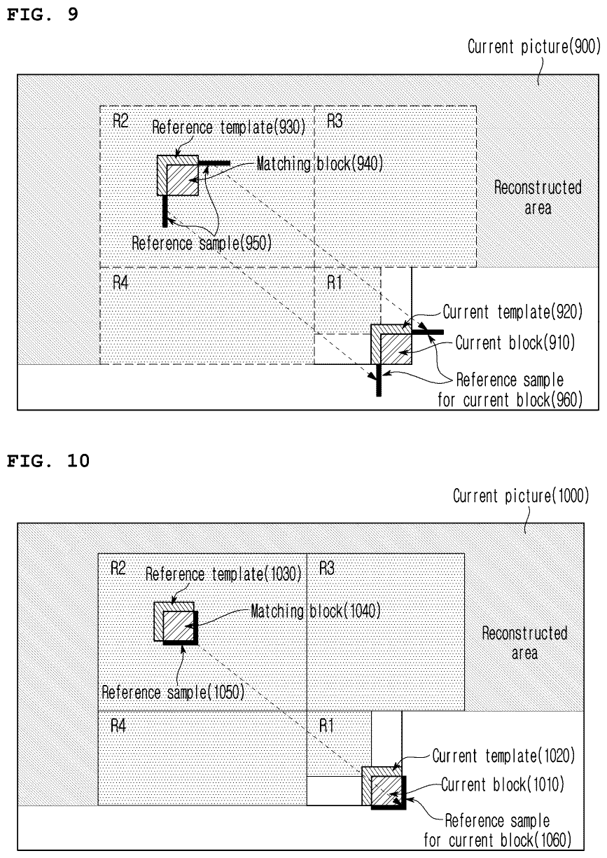

FIGS. 9 to 11 are diagrams for explaining a template matching-based reference sample derivation method according to an embodiment of the present invention. Specifically, FIGS. 9, 10 and 11 are diagrams for explaining a template matching-based reference sample derivation method for constructing a first type reference sample area, a second type reference sample area and a third type reference sample area, respectively.

An Intra Template Matching Prediction (Intra TMP) method means a method of searching for an optimal prediction block in a reconstructed area of a current picture using template matching and copying it to generate a prediction block of a current block. In the template matching-based reference sample derivation method described in FIGS. 9 to 11, reference samples around a current block may be derived from a reconstructed area similarly to the above-described template matching-based intra prediction method.

Referring to FIG. 9, the neighboring ┌ area (i.e., the left, upper, and left upper area) of a current block 910 may be defined as a current template 920. Then, a reference template 930 most similar to the current template 920 may be searched within predefined search ranges R1, R2, R3 and R4 of the reconstructed area of a current picture 900. Then, a left bottom reference sample and right upper reference sample 960 of an unreconstructed area of the current block 910 may be derived based on the left bottom sample and right upper sample 950 of a corresponding matching block 940 of the determined reference template 930.

Referring to FIG. 10, the neighboring ┌ area (i.e., the left, upper, and left upper areas) of a current block 1010 may be defined as a current template 1020. Then, the reference template 1030 most similar to the current template 1020 may be searched within predefined search ranges R1, R2, R3 and R4 of a reconstructed area of a current picture 1000. Then, a bottom reference sample, right reference sample, and right bottom reference sample 1060 of an unreconstructed area of the current block 1010 may be derived based on a bottom sample, right sample, and right bottom sample 1050 of a corresponding matching block 1040 of the determined reference template 1030.

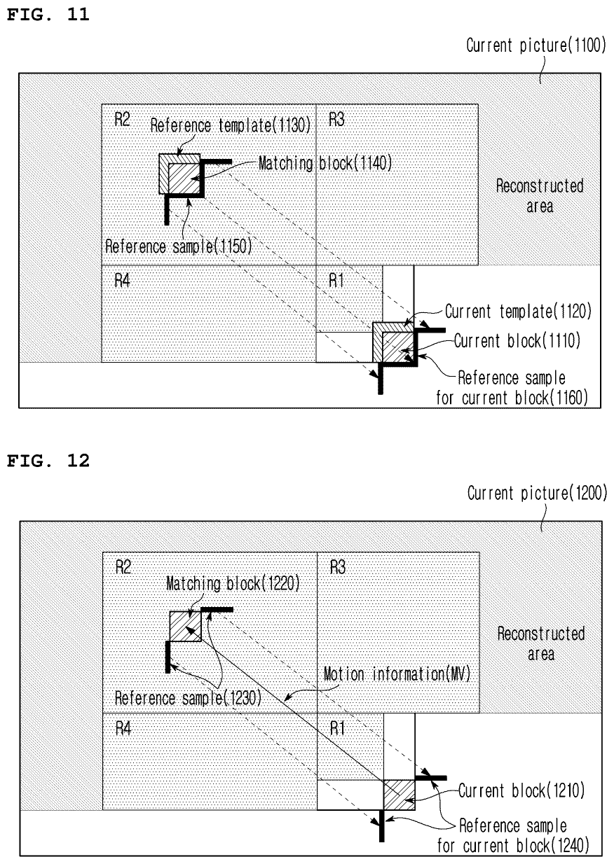

Referring to FIG. 11, the neighboring ┌ area (i.e., the left, upper and left upper area) of a current block 1110 may be defined as a current template 1120. Then, a reference template 1130 most similar to the current template 1120 may be searched within predefined search ranges R1, R2, R3 and R4 of a reconstructed area of a current picture 1100. Then, a left bottom reference sample, right upper reference sample, bottom reference sample, right reference sample and the right bottom reference sample 1160 of an unreconstructed area of the current block 1110 may be derived based on the left bottom sample, right upper sample, bottom sample, right sample and the right bottom sample 1150 of a corresponding matching block 1040 of the determined reference template 1130.

The predefined search ranges R1, R2, R3, and R4 in FIGS. 9 to 11 may be defined as a current CTU (Coding Tree Unit), the left upper CTU, the upper CTU, and the left CTU, respectively, including the current block.

In addition, within the predefined search range, reference templates may be searched based on a predefined search order. For example, the reference templates may be searched in the zigzag order of R1, R4, R3, and R2.

Meanwhile, information about the search range and the size and shape of the current template may be determined by the encoder and transmitted to the decoder.

In the template matching-based reference sample derivation method proposed in FIGS. 9 to 11, reference samples may be derived by performing the same template matching process as the encoder in the decoder without signaling (transmitting/parsing) the syntax related to the reference sample derivation.

FIGS. 12 to 14 are diagrams for explaining a motion information-based reference sample derivation method according to an embodiment of the present invention. Specifically, FIGS. 12, 13, and 14 are diagrams for explaining a motion information-based reference sample derivation method for constructing a first type reference sample area, a second type reference sample area, and a third type reference sample area, respectively. Unlike the template matching-based reference sample derivation method described above, in the motion information-based reference sample derivation method described in FIGS. 12 to 14, reference samples are derived by transmitting/parsing syntax related to motion information.

Referring to FIG. 12, a matching block 1220 may be derived within predefined search ranges R1, R2, R3 and R4 of a reconstructed area of a current picture 1200 based on motion information (motion vector) of a current block 1210. In addition, a left bottom reference sample and right upper reference sample 1240 of an unreconstructed area of the current block 1210 may be derived based on a left bottom sample and right upper sample 1230 of a matching block 1220.

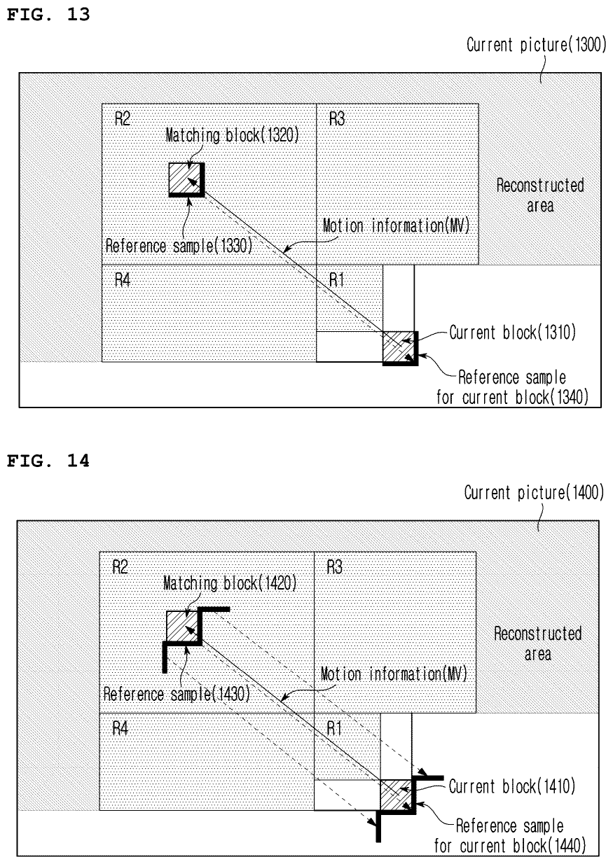

Referring to FIG. 13, a matching block 1320 may be derived within predefined search ranges R1, R2, R3 and R4 of a reconstructed area of a current picture 1300 based on motion information (motion vector) of a current block 1310. In addition, a bottom reference sample, right reference sample, and right bottom reference sample 1340 of an unreconstructed area of the current block 1310 may be derived based on a bottom sample, right sample, and bottom right sample 1330 of a matching block 1320.

Referring to FIG. 14, a matching block 1420 may be derived within predefined search ranges R1, R2, R3 and R4 of a reconstructed area of a current picture 1400 based on motion information (motion vector) of a current block 1410. In addition, a left bottom reference sample, a right upper reference sample, a bottom reference sample, a right reference sample, and a right bottom reference sample 1440 of an unreconstructed area of the current block 1410 may be derived based on a left bottom sample, right upper sample, bottom sample, right sample, and bottom right sample 1430 of a matching block 1420.

Although it has been described that matching block is derived within the defined search ranges in FIGS. 12 to 14, the matching block may be derived based on motion information in the reconstructed area within the current picture.

Meanwhile, motion information for deriving reference samples may be determined by the encoder and transmitted to the decoder.

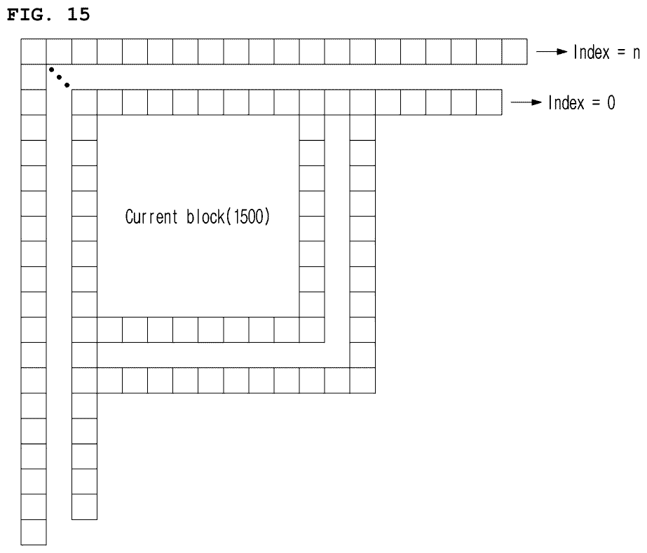

FIG. 15 is a diagram for explaining an embodiment of a plurality of reference sample lines according to an embodiment of the present invention. In FIGS. 4 to 14, the reference sample for intra prediction is described as one sample line, but it is not limited thereto, and the reference sample may be determined from at least one sample line among a plurality of sample lines as in FIG. 15. That is, reference samples of a plurality of reference sample lines may be derived according to the reference sample derivation method according to FIGS. 4 to 14.

Meanwhile, the plurality of reference sample lines may be identified by indices. For example, the indices (0 to n, n is a positive integer) may be set in the order adjacent to the current block 1500.

Hereinafter, an intra prediction method using reference samples derived by the above-described reference sample derivation method will be described for each intra prediction mode.

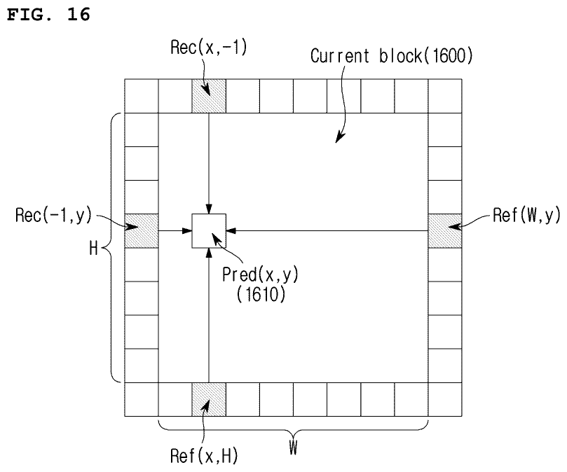

FIG. 16 is a diagram for explaining a planar mode according to an embodiment of the present invention.

In the planar mode according to an embodiment of the present invention, intra prediction may be performed using left and upper reconstructed reference samples and the right and bottom derived reference samples. Here, the right and bottom derived reference samples may be derived by the reference sample derivation method described above.

In FIG. 16, Pred(x, y) represents a current pixel 1610 to be predicted, Rec(−1, y) and Rec(x, −1) represent reconstructed reference samples corresponding to the left and top of the current pixel, respectively, and Ref(W, y) and Ref(x, H) represent derived reference samples corresponding to the right and bottom of the current pixel, respectively. In addition, W and H represent the width (horizontal) and height (vertical) of a current block 1600.

The current pixel Pred(x, y) for the planar mode according to an embodiment of the present invention may be calculated using Equations 1 to 3.

$$PrevD ( x , y ) = ( ( H - 1 - y ) \times Rec ( x , - 1 ) + ( y + 1 ) \times Ref ( x , H ) ) >> {log}_{2} H \qquad [ Equation 1 ]$$

$$PredH ( x , y ) = ( ( W - 1 - x ) \times Rec ( - 1 , y ) + ( x + 1 ) \times Ref ( W , y ) ) >> {log}_{2} W \qquad [ Equation 2 ]$$

$$\begin{matrix}Pred ( x , y ) = ( PredV ( x , y ) \times predH ( x , y ) + W \times H ) >> ( {log}_{2} W + {log}_{2} H + 1 ) & [ Equation 3 ]\end{matrix}$$

When the intra prediction mode is the planar mode, the prediction block of the current block may be generated by calculating the prediction value for all pixels (0≤x≤w−1, 0≤y≤H−1) in the current block using Equations 1 to 3.

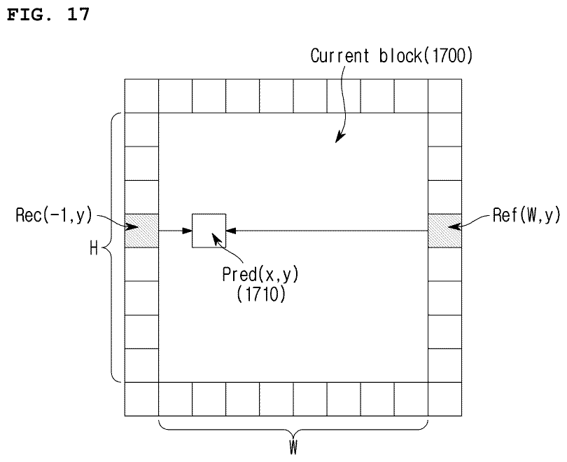

FIG. 17 is a diagram for explaining a horizontal planar mode according to an embodiment of the present invention.

In the horizontal planar mode according to an embodiment of the present invention, intra prediction may be performed using a left reconstructed reference sample and a right derived reference sample. Here, the right derived reference sample may be derived by the reference sample derivation method described above.

In FIG. 17, Pred(x, y) represents a current pixel 1710 to be predicted, Rec(−1, y) represents a reconstructed reference sample corresponding to the left of the current pixel, and Ref(W, y) represents a derived reference sample corresponding to the right of the current pixel. In addition, W and H represent the width (horizontal) and height (vertical) of a current block 1700.

The current pixel Pred(x, y) for the horizontal planar mode according to an embodiment of the present invention may be calculated using Equation 4.

$$Pred ( x , y ) = ( ( W - 1 - x ) \times R e c ( - 1 , y ) + ( x + 1 ) \times Ref ( W , y ) + ( W >> 1 ) ) >> {log}_{2} W \qquad [ Equation 4 ]$$

When the intra prediction mode is the horizontal planar mode, the prediction block of the current block may be generated by calculating the prediction value for all pixels (0≤x≤w−1, 0≤y≤H−1) in the current block using Equation 4.

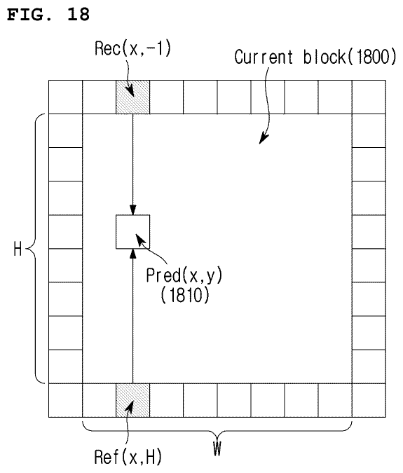

FIG. 18 is a diagram for explaining a vertical planar mode according to an embodiment of the present invention. In the vertical planar mode according to an embodiment

of the present invention, intra prediction may be performed using an upper reconstructed reference sample and a bottom derived reference sample. Here, the bottom derived reference sample may be derived by the reference sample derivation method described above.

In FIG. 18, Pred(x, y) represents a current pixel 1810 to be predicted, Rec(x,−1) represents a reconstructed reference sample corresponding to the top of the current pixel, and Ref(x, H) represents a derived reference sample corresponding to the bottom of the current pixel. In addition, W and H represent the width (horizontal) and height (vertical) of a current block 1800.

The current pixel Pred(x, y) for the vertical planar mode according to an embodiment of the present invention may be calculated using Equation 5.

$$Pred ( x , y ) = ( ( H - 1 - y ) \times Rec ( x , - 1 ) + ( y + 1 ) \times Ref ( x , H ) + ( H >> 1 ) ) >> {log}_{2} H \qquad [ Equation 5 ]$$

When the intra prediction mode is the vertical planar mode, the prediction block of the current block may be generated by calculating the prediction value for all pixels (0≤x≤W−1, 0≤y≤H−1) in the current block using Equation 5.

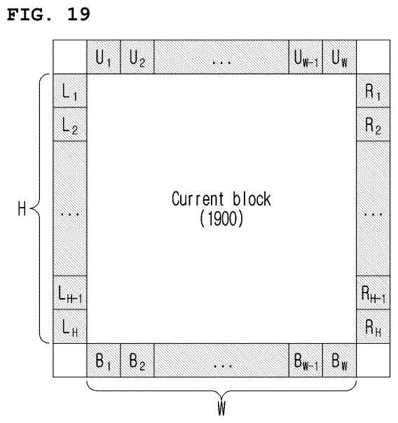

FIG. 19 is a diagram for explaining a DC mode according to an embodiment of the present invention.

In the DC mode according to an embodiment of the present invention, intra prediction may be performed using left and upper reconstructed reference samples and right and bottom derived reference samples. Here, the right and bottom derived reference samples may be derived by the reference sample derivation method described above.

In FIG. 19, U₁˜U_{W} and L₁˜L_{G} represent upper and left reconstructed samples, and R₁˜R_{H} and B₁˜B_{W} represents right and bottom derived reference samples. In addition, W and H represent the width (horizontal) and height (vertical) of a current block 1900.

In the DC mode according to an embodiment of the present invention, the same prediction value may be allocated to all pixels in the current block, and the prediction value may be calculated using Equation 6.

$$dcVal = ( {\sum }_{i = 1}^{W} {U}_{i} + {\sum }_{j = 1}^{H} {L}_{j} + {\sum }_{k = 1}^{W} {B}_{k} + {\sum }_{l = 1}^{H} {R}_{l} + ( W + H ) ) / ( 2 \times ( W + H ) ) \qquad [ Equation 6 ]$$

Also, a prediction block for the DC mode may be generated by generating a prediction value for the DC mode using Equation 6 and allocating it to all pixels (0≤x≤w−1, 0≤y≤H−1) in the current block.

If the intra prediction mode is the DC mode, the prediction block of the current block may be generated by allocating the prediction value calculated using Equation 6 to all pixels (0≤x≤w−1, 0≤y≤H−1) in the current block.

In FIG. 19, the prediction value for the DC mode is calculated using all neighboring reference samples of the current block.

However, this is an example, and a pixel value at a specific location may be sampled and selected in consideration of complexity, and then the prediction value for the DC mode may be calculated using the selected pixel value.

As an example, one pixel may be sampled from each of the left reference sample, the upper reference sample, the right reference sample, and the bottom reference sample, and the prediction value for the DC mode may be calculated based on the sampled pixels. In this case, the prediction value for the DC mode may be calculated using Equation 7 or Equation 8.

$$dcVal = ( {\sum }_{i = 1}^{W / 2} {U}_{i << 1} + {\sum }_{j = 1}^{H / 2} {L}_{j 〈 〈 1} + {\sum }_{k = 1}^{W / 2} {B}_{k 〈 〈 1} + {\sum }_{l = 1}^{H / 2} {R}_{l 〈 〈 1} + ( ( W + H ) >> 1 ) ) \text{} / ( W + H ) \qquad [ Equation 7 ]$$

$$dcVal = ( {\sum }_{i = 1}^{\frac{W}{2}} {U}_{i 〈 〈 1 - 1} + {\sum }_{j = 1}^{\frac{H}{2}} {L}_{j 〈 〈 1 - 1} + {\sum }_{k = 1}^{\frac{W}{2}} {B}_{k 〈 〈 1 - 1} + {\sum }_{l = 1}^{\frac{H}{2}} {R}_{l 〈 〈 1 - 1} + ( ( W + H ) >> 1 ) ) \text{} / ( W + H ) \qquad [ Equation 8 ]$$

In Equation 7 or Equation 8, the prediction value for the DC mode is calculated by sampling one pixel from each of the left reference sample, the upper reference sample, the right reference sample, and the bottom reference sample.

Meanwhile, according to an embodiment of the present invention, the prediction value for the DC mode may be calculated by sampling N pixels from each of the left reference sample, the upper reference sample, the right reference sample, and the bottom reference sample. Here, N may be any positive integer.

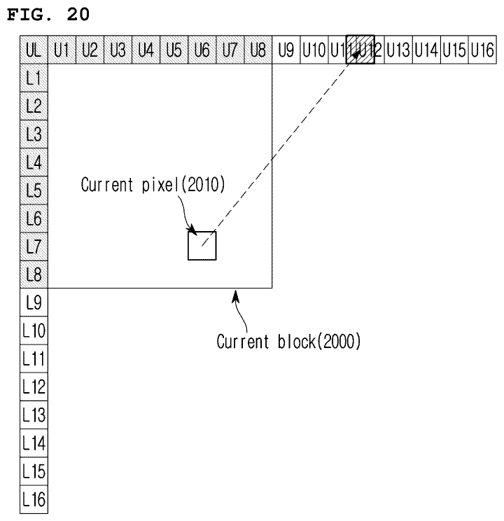

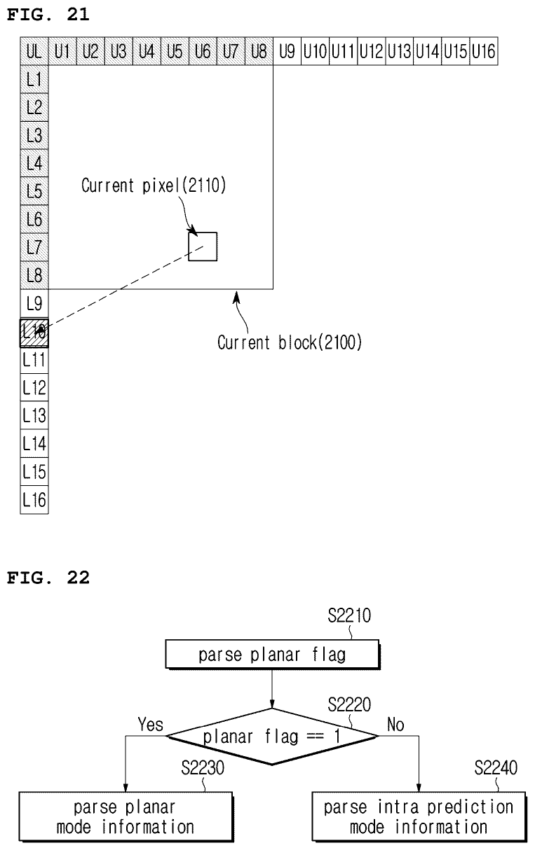

FIGS. 20 and 21 are diagrams for explaining an angular mode according to an embodiment of the present invention.

FIG. 20 is a diagram for explaining intra prediction using right upper reference samples U9 to U16 when the intra prediction mode is an angular mode greater than the vertical mode (i.e., when the intra prediction mode is an angular mode indicating a clockwise direction with respect to the vertical direction).

Referring to FIG. 20, the dotted line indicates the directionality of the intra prediction mode. If a current block 2000 is in the same situation as the C4 sub-block of FIG. 4, there is a problem that the right upper reference sample U9 to U16 are not reconstructed and thus cannot be used as reference samples for intra prediction of a current pixel 2010.

As described in FIG. 4, the right upper reference samples U9 to U16 may be derived by padding based on the previously reconstructed neighboring samples U1 to U8. However, when the right upper reference samples are derived by padding, it is difficult to reflect the characteristics of each reference sample of the corresponding area. Therefore, the reference sample accuracy is low, and the accuracy of intra prediction may be lowered.

Meanwhile, the right upper reference samples U9 to U16 may be derived based on any one of the neural network-based reference sample prediction method, the template matching-based reference sample prediction method, and the motion information-based reference sample prediction method according to an embodiment of the present invention.

FIG. 21 is a diagram for explaining intra prediction using left bottom reference samples L9 to L16 when the intra prediction mode is an angular mode smaller than the horizontal mode (i.e., when the intra prediction mode is an angular mode indicating a counterclockwise direction based on the horizontal direction).

Referring to FIG. 21, the dotted line indicates the directionality of the intra prediction mode. If a current block 2100 is in the same situation as the C4 sub-block of FIG. 4, there is a problem that left bottom reference samples L9 to L16are not reconstructed and thus cannot be used as reference samples for intra prediction of a current pixel 2110.

As described in FIG. 4, the left bottom reference samples L9 to L16 may be derived by padding based on the previously reconstructed neighboring samples L1 to L8. However, when the left bottom reference samples are derived by padding, it is difficult to reflect each characteristic of the reference sample in the corresponding area. Therefore, the accuracy of the reference samples may be low, and the accuracy of the intra prediction may be lowered.

Meanwhile, the left bottom reference samples L9 to L16 may be derived based on any one of the neural network-based reference sample prediction method, the template matching-based reference sample prediction method, and the motion information-based reference sample prediction method according to an embodiment of the present invention.

Meanwhile, the bottom reference samples and the right reference samples may be derived by any one of the neural network-based reference sample prediction method, the template matching-based reference sample prediction method, and the motion information-based reference sample prediction method according to an embodiment of the present invention. Accordingly, the angular intra prediction mode may include all modes representing 360 degrees omnidirectional. By enabling 360 degrees omnidirectional intra prediction through the reference samples derived in this way, the problem of the unidirectional intra prediction using only the previously reconstructed reference sample, which is the problem of the prediction accuracy of the current sample far from the reconstructed reference sample being low, can be solved.

In addition, by deriving the bottom reference sample and the right reference sample, bidirectional intra prediction may be enabled. Here, bidirectional intra prediction is an intra prediction method that generates a prediction value by a weighted sum of the reference sample determined based on the direction of the intra prediction mode and the reference sample determined based on the opposite direction of the intra prediction mode.

FIG. 22 is a flowchart illustrating an intra prediction mode parsing method according to an embodiment of the present invention.

The planar mode and DC mode according to an embodiment of the present invention are modes that replace the existing planar mode and DC mode, while the horizontal planar mode and the vertical planar mode are new prediction modes that do not exist in the existing intra prediction modes. If the horizontal planar mode and the vertical planar mode are used, the number of intra prediction modes may increase by 2.

Hereinafter, a method of transmitting/parsing horizontal planar mode and vertical planar mode information will be described.

The horizontal planar mode and the vertical planar mode are considered as angular modes, and information about the horizontal planar mode and the vertical planar mode may be transmitted/parsed. In this case, the number of angular modes increases by two, but the same syntax transmission/parsing method as the existing method may be used.

Meanwhile, a planar flag and planar mode information may be transmitted/parsed. Here, the planar flag may indicate whether one of the planar mode, the horizontal planar mode, and the vertical planar mode is performed, and the planar mode information may indicate which of the planar mode, the horizontal planar mode, and the vertical planar mode is performed.

FIG. 22 is a flowchart illustrating a method of parsing intra prediction mode information.

Referring to FIG. 22, the image decoding apparatus may parse a planar flag (S2210). Then, if the parsed planar flag indicates that one of the planar mode, the horizontal planar mode, and the vertical planar mode is used (S2220—Yes), the image decoding apparatus may parse the planar mode information to determine the intra prediction mode to be one of the planar mode, the horizontal planar mode, and the vertical planar mode (S2230).

On the other hand, if the parsed planar flag indicates that none of the planar mode, horizontal planar mode, and vertical planar mode is used (S2220—No), the image decoding apparatus may determine the intra prediction mode by parsing the intra prediction mode information excluding the planar mode (S2240).

TABLE 1

| Mode | Codeword |
|---|---|
| Planar mode | 0 (or 1) |
| Horizontal planar | 10 (or 01) |
| mode | |
| Vertical planar | 11 (or 00) |
| mode | |

Table 1 is a table showing codewords of the planar mode, the horizontal planar mode, and the vertical planar mode. In Table 1, codewords of the horizontal planar mode and the vertical planar mode may be arbitrarily determined. For example, the codeword of the horizontal planar mode may be assigned as 11 (or 00), and the codeword of the vertical planar mode may be assigned as 10 (or 01).

Meanwhile, when the reference sample derivation method of the present invention is selectively applied only to the planar mode and the DC mode, the bottom reference sample and the right reference sample may be derived based on any one of the neural network-based reference sample prediction method, the template matching-based reference sample prediction method, and the motion information-based reference sample prediction method.

Alternatively, when the reference sample derivation method of the present invention is selectively applied only to the angular mode, the right upper reference sample and the left bottom reference sample may be derived based on any one of the neural network-based reference sample prediction method, the template matching-based reference sample prediction method, and the motion information-based reference sample prediction method.

Alternatively, when the reference sample derivation method of the present invention is applied to the planar mode, the horizontal planar mode, the vertical planar mode, the DC mode, and the angular mode, the right upper reference sample, the left bottom reference sample, the bottom reference sample, the right bottom reference sample, and the right reference sample may be derived based on any one of the neural network-based reference sample prediction method, the template matching-based reference sample prediction method, and the motion information-based reference sample prediction method.

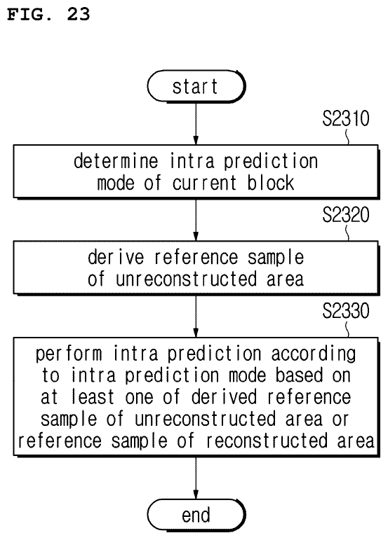

FIG. 23 is a flowchart illustrating an image decoding method according to an embodiment of the present invention. The image decoding method of FIG. 23 may be performed by an image decoding apparatus.

The image decoding apparatus may determine an intra prediction mode of a current block (S2310). Here, the intra prediction mode may be determined to be one of the planar mode, the vertical planar mode, the horizontal planar mode, the DC mode, and the angular mode.

Specifically, the step of determining the intra prediction mode may include the step of parsing a planar flag, and the step of parsing one of the planar mode information and the intra prediction mode information according to the planar flag to determine the intra prediction mode.

The planar flag may be information indicating whether one of the planar mode, the horizontal planar mode, and the vertical planar mode is performed.

The planar mode information may be information indicating which of the planar mode, the horizontal planar mode, and the vertical planar mode is performed.

The intra prediction mode information may be information indicating an intra prediction mode other than the planar mode, the horizontal planar mode, and the vertical planar mode.

Meanwhile, a method of determining an intra prediction mode by parsing a planar flag, planar mode information, and intra prediction mode information will be described in detail in FIG. 22.

Then, the image decoding apparatus may derive a reference sample of an unreconstructed area (S2320). Here, the reference sample of the unreconstructed area may be a reference sample of an area located at at least one of the left bottom, bottom, right bottom, right, and right top of the current block.

Meanwhile, the reference sample of the unreconstructed area may be derived based on a neighboring sample of a matching block searched by performing template matching.

Alternatively, the sample reference of the unreconstructed area may be derived based on the neighboring samples of the matching block in the current picture indicated by the motion information of the current block.

Alternatively, the reference sample of the unreconstructed area may be derived based on a neural network model having the reference sample of the reconstructed area as input.

Meanwhile, the method of deriving the reference sample of the unreconstructed area has been described in detail in FIGS. 4 to 15.

Then, the image decoding apparatus may perform intra prediction according to the intra prediction mode based on at least one of the derived reference sample of the unreconstructed area or the reference sample of the reconstructed area (S2330).

If the intra prediction mode of the current block is determined to be the planar mode, intra prediction may be performed based on the reference sample of the reconstructed area corresponding to the top of the current pixel, the reference sample of the reconstructed area corresponding to the left, the reference sample of the unreconstructed area corresponding to the bottom, and the reference sample of the unreconstructed area corresponding to the right.

If the intra prediction mode of the current block is determined to be the vertical planar mode, the image decoding method may perform intra prediction based on a reference sample of the reconstructed area corresponding to the top of the current pixel and a reference sample of an unreconstructed area corresponding to the bottom.

If the intra prediction mode of the current block is determined to be the horizontal planar mode, the image decoding method may perform intra prediction based on a reference sample of a reconstructed area corresponding to the left of the current pixel and a reference sample of an unreconstructed area corresponding to the right.

If the intra prediction mode of the current block is determined to be the DC mode, the image decoding method may perform intra prediction based on a reference sample of a reconstructed area located at the top of the current block, a reference sample of a reconstructed area located at the left, a reference sample of an unreconstructed area located at the bottom, and a reference sample of an unreconstructed area located at the right.

Meanwhile, the intra prediction method according to the intra prediction mode will be described in detail in FIGS. 16 to 21.

Meanwhile, the steps described in FIG. 23 may be performed in the same manner in the image encoding method. In addition, a bitstream may be generated by the image encoding method including the steps described in FIG. 23. The bitstream may be stored in a non-transitory computer-readable recording medium, and may also be transmitted (or streamed).

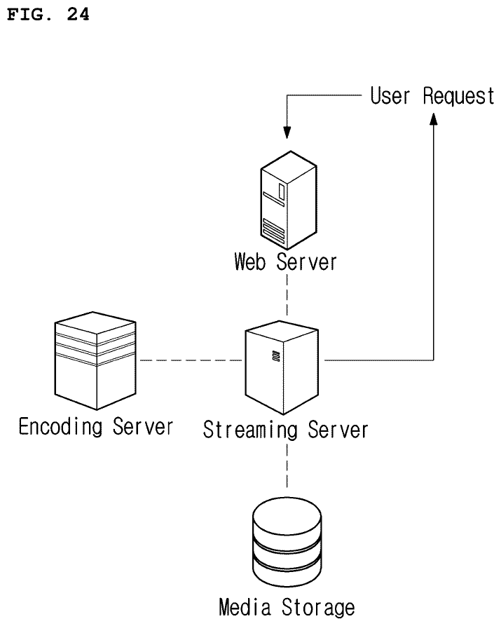

FIG. 24 exemplarily illustrates a content streaming system to which an embodiment according to the present invention is applicable.

As illustrated in FIG. 24, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from a media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus. The above embodiments may be performed for each of the

luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

The present invention may be used in an apparatus for encoding/decoding an image and a recording medium for storing a bitstream.

1. An image decoding method comprising:
determining an intra prediction mode of a current block;
deriving a reference sample of an unreconstructed area; and
performing intra prediction according to the intra prediction mode based on at least one of the derived reference sample of the unreconstructed area or a reference sample of a reconstructed area,
wherein the reference sample of the unreconstructed area is a reference sample of an area located at at least one of a left bottom, bottom, right bottom, right or right top of the current block.

2. The image decoding method of claim 1, wherein the reference sample of the unreconstructed area is derived based on neighboring samples of a matching block searched by performing template matching.

3. The image decoding method of claim 1, wherein the reference sample of the unreconstructed area is derived based on neighboring samples of a matching block in a current picture indicated by motion information of the current block.

4. The image decoding method of claim 1, wherein the reference sample of the unreconstructed area is derived based on a neural network model having the reference sample of the reconstructed area as input.

5. The image decoding method of claim 1, wherein the intra prediction mode is determined to be any one of a planar mode, a vertical planar mode, a horizontal planar mode, a DC mode or an angular mode.

6. The image decoding method of claim 5, wherein when the intra prediction mode is determined to be a planar mode, intra prediction is performed based on a reference sample of a reconstructed area corresponding to the top of a current pixel, a reference sample of a reconstructed area corresponding to the left, a reference sample of an un reconstructed area corresponding to the bottom and a reference sample of an unreconstructed area corresponding to the right.

7. The image decoding method of claim 5, wherein when the intra prediction mode is determined to be a vertical planar mode, intra prediction is performed based on a reference sample of a reconstructed area corresponding to the top of a current pixel and a reference sample of an unreconstructed area corresponding to the bottom.

8. The image decoding method of claim 5, wherein when the intra prediction mode is determined to be a horizontal planar mode, intra prediction is performed based on a reference sample of a reconstructed area corresponding to the left of a current pixel and a reference sample of an unreconstructed area corresponding to the right.

9. The image decoding method of claim 5, wherein when the intra prediction mode is determined to be a DC mode, intra prediction is performed based on a reference sample of a reconstructed area located at the top of the current block, a reference sample of a reconstructed area located at the left, a reference sample of an unreconstructed area located at the bottom and a reference sample of an unreconstructed area located at the right.

10. The image decoding method of claim 5, wherein the determining the intra prediction mode comprises:
parsing a planar flag; and
determining the intra prediction mode by parsing any one of planar mode information and intra prediction mode information according to the planar flag.

11. An image encoding method comprising:
determining an intra prediction mode of a current block;
deriving a reference sample of an unreconstructed area; and
performing intra prediction according to the intra prediction mode based on at least one of the derived reference sample of the unreconstructed area or a reference sample of a reconstructed area, wherein the reference sample of the unreconstructed area is a reference sample of an area located at at least one of a left bottom, bottom, right bottom, right or right top of the current block.

12. (canceled)

13. A method of transmitting a bitstream generated by an image encoding method, the method comprising:
transmitting the bitstream,
wherein the encoding method comprising:
determining an intra prediction mode of a current block;
deriving a reference sample of an unreconstructed area; and
performing intra prediction according to the intra prediction mode based on at least one of the derived reference sample of the unreconstructed area or a reference sample of a reconstructed area,
wherein the reference sample of the unreconstructed area is a reference sample of an area located at at least one of a left bottom, bottom, right bottom, right or right top of the current block.
